(19) United States
(12) Patent Application Publication
(10) Pub. No.: US 2010/0148008 A1
(43) Pub. Date: Jun. 17, 2010

(54) RIB-FITTING

(75) Inventors: Esperanza HERNANDO SEBASTIAN, Madrid (ES); Felix DOMINGUEZ ESCAURIAZA, Madrid (ES); Francisco Jose FERNANDEZ SANCHEZ, Madrid (ES)

Correspondence Address: LADAS & PARRY LLP, 26 WEST 61ST STREET, NEW YORK, NY, 10023, US

(73) Assignees: AIRBUS ESPANA, S.L.; FUNDACION PARA LA INVESTIGACION DE MATERIALES COMPUESTOS (FIDAMC)

(21) Appl. No.: 12/372,162

(22) Filed: Feb. 17, 2009

(30) Foreign Application Priority Data
Dec. 17, 2008 (ES) ES 200803580

(51) Int. Cl. B64C 1/06; B23P 11/00

(52) U.S. Cl. 244/131; 29/428

(57) ABSTRACT

Rib-fitting as a component (9) of a torsion box (1, 3) of an aircraft lift surface made of composite material as a single piece, comprising: a substantially planar web (31) with a first part in the form of a lug (33) and a second part in the form of a rib web (35); two flanges (39) to attach the web (31) with the webs of each of the ends of the front or back spar (11, 13) to which it is joined; flanges (43) for being attached to the upper and lower skins (19, 21) of the torsion box; gaps (45) in the areas of intersection with the front or back spar caps (11, 13) to which the component (9) is connected and with the reinforcement stringers (25) of the skins (19, 21). The invention also comprises and assembly process for the rib-fitting in multispar torsion boxes.

### FIELD OF THE INVENTION

The present invention refers to a component of an aircraft lift surface torsion box for receiving and distributing a local load.

### BACKGROUND OF THE INVENTION

Structures of aeronautical lift surfaces are traditionally formed by a torsion box in their resistant and load transit part.

One of the known configurations is the multi-rib configuration according to which the box is formed by two spars, closed by skins and reinforced against torsional loads by uniformly distributed ribs.

Another of the known configurations is the multi-spar configuration according to which the box is formed by two spars, closed by skins and reinforced against torsional loads by uniformly distributed inner spars.

Local load concentrations in torsion boxes coming from structures bound to it, such as pylons, control surfaces or supports in the fuselage, are usually introduced in the structure of the box through a fitting (usually formed by several parts) transmitting the load to a back-fitting (a rib in the case of a multi-rib box) which in turn distributes it to the rest of the box structure.

This way of introducing loads requires a large number of parts which are furthermore difficult to attach to one another, at the same time requiring a large amount of bolts which must have precise tightening torques and very low tolerances, which leads to consuming a considerable amount of assembly time and investing a lot of time in such assembly.

In an increasingly more competitive market, it is necessary to produce structures at the lowest possible cost and in the shortest possible time. Within this framework, it would be desirable to reduce the number of parts of the assembly of the mentioned fitting and back-fitting and to simplify their assembly process.

The present invention seeks to meet this demand.

### SUMMARY OF THE INVENTION

An object of the present invention is to provide a component of an aircraft lift surface torsion box for receiving and distributing a local load made as a single piece.

Another object of the present invention is to provide a component of an aircraft lift surface torsion box for receiving and distributing a local load with the lowest possible weight.

Another object of the present invention is to provide a component of an aircraft lift surface torsion box for receiving and distributing a local load, which can be easily assembled.

Another object of the present invention is to provide efficient assembly processes for the cited component.

In a first aspect, these and other objects are achieved by means of a part of a torsion box (comprising at least two front and back spars, two upper and lower skins with reinforcement stringers) which is made of a composite material as a single piece and the configuration of which comprises:
a substantially planar web with a first part in the form of a lug and a second part in the form of a rib
Two flanges to attach the component web to the webs of each of the ends of the front or back spar
Flanges for being attached to the upper and lower skins.
gaps in the areas of intersection with the front or back spar caps to which the component is connected and with the reinforcement stringers.

In a preferred embodiment of said component, the flanges for being attached to the upper and lower skins extend in opposite directions in relation to the plane of the web for each of the upper and lower skins. This achieves a component with a Z-shaped transverse profile facilitating its assembly in certain box configurations.

In another particular embodiment of said component, the flanges for being attached to the upper and lower skins extend on both sides of the plane of the web for each of the upper and lower skins. This achieves a double T-shaped transverse profile which very efficiently transmits the load to the torsion box.

In a second aspect, an assembly process for assembling the is mentioned component in a multi-spar box is provided comprising the following steps:

Providing the pre-assembled torsion box with the two skins.

Providing a component with the mentioned configuration of a Z-shaped profile.

Introducing said component rotated a predetermined angle into the box.

Moving said component to the site provided for its location and rotating it until it is correctly positioned.

Coupling the component with the ends of the front or back spar to which it is connected.

Attaching the component to the two skins and to the ends of the front or back spar to which it is connected.

In a third aspect, an assembly process for assembling the mentioned component in a multi-spar box is provided comprising the following steps:

Providing the pre-assembled torsion box with the two skins.

Providing a component with the mentioned configuration of a double T-shaped profile.

Introducing said component into the box in the vertical position.

Moving said component to the site provided for its location and correctly positioning it.

Coupling the component with the ends of the front or back spar to which it is connected.

Attaching the component to the two skins and to the ends of the front or back spar to which it is connected.

Other features and advantages of the present invention will be understood from the following detailed description of an illustrative embodiment of the object of the invention in relation to the attached drawings.

### DESCRIPTION OF THE DRAWINGS

FIG. 1a shows a perspective view of a known multi-rib configuration torsion box and FIG. 1b shows a cross-section view of FIG. 1a along plane A-A.

FIG. 2 shows a partial perspective view of a known multi-rib torsion box with a fitting-back-fitting assembly at a point of introducing a load into the box.

FIGS. 3a and 3b show cross-section views of known fitting-back-fitting assemblies for introducing loads into a multi-rib torsion box.

FIG. 4a shows a perspective view of a known multi-spar configuration torsion box, and FIG. 4b shows a typical cross-section view of this type of torsion box.

FIG. 5 shows a cross-section view of a known fitting-back-fitting assembly for introducing loads into a multi-spar torsion box.

FIG. 6a shows a schematic cross-section view of a known attachment for a fitting-back-fitting assembly to the torsion box.

FIG. 6b shows a schematic cross-section view of the attachment of the component for receiving and distributing a local load to the torsion box, according to the present invention.

FIG. 7a shows a perspective view of a preferred embodiment of a component for receiving and distributing a local load to the torsion box, according to the present invention.

FIG. 7b shows a schematic side-section view of the component of FIG. 7a assembled to the torsion box.

FIG. 8 illustrates the assembly process for assembling the component of FIG. 7a to the torsion box.

FIG. 9a shows a perspective view of another preferred embodiment of a component for receiving and distributing a local load to the torsion box, according to the present invention.

FIG. 9b shows a schematic side-section view of the component of FIG. 9a assembled to the torsion box.

FIG. 10 illustrates the assembly process for assembling the component of FIG. 9a to the torsion box.

### DETAILED DESCRIPTION OF THE INVENTION

The known art for introducing and distributing local loads to an aircraft lift surface torsion box will be briefly described first.

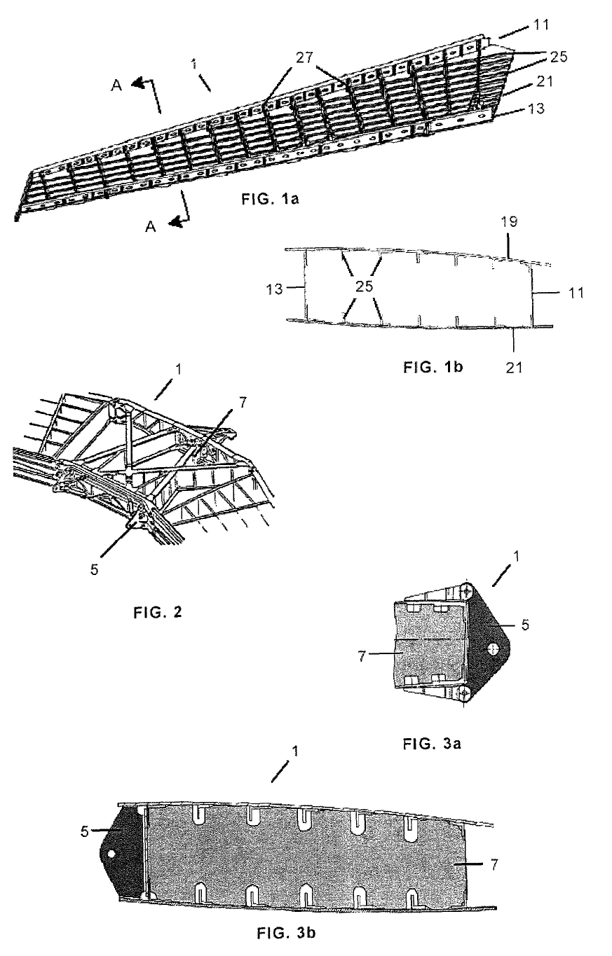

A multi-rib configuration torsion box 1 such as the one depicted in FIGS. 1a and 1b is structurally based on a front spar 11 and a back spar 13 (understanding the terms front and back in relation to the flight direction of the aircraft), two upper and lower skins 19, 21 with a plurality of reinforcement stringers 25 and a plurality of transverse ribs 27.

Fittings 5, such as the one depicted in FIG. 2, are included in this type of torsion box 1 for receiving local loads that are distributed to the rest of the box through the back-fitting 7.

Two embodiments of these fitting 5 back-fitting 7 assemblies are observed in FIGS. 3a and 3b in which the back-fittings 7 are similar to the transverse ribs 27.

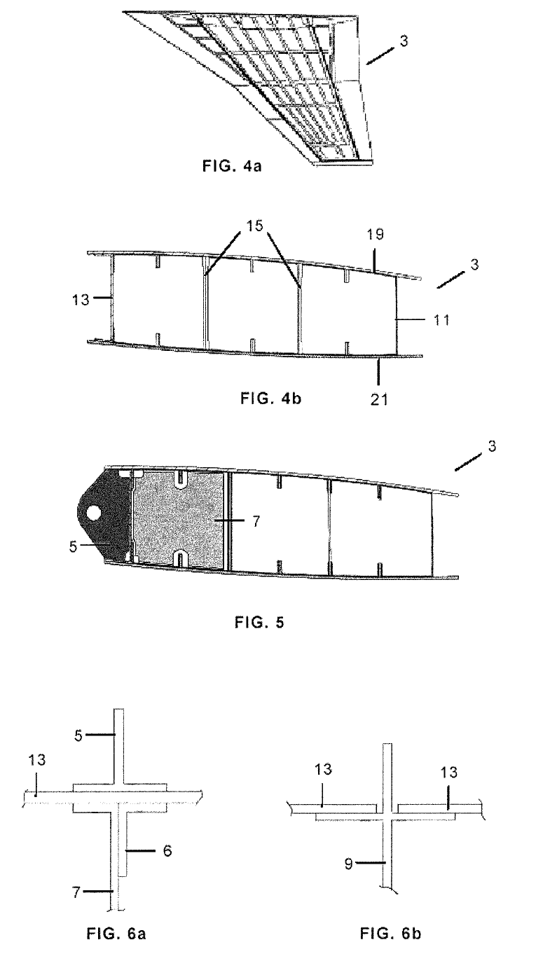

In addition, a multi-spar configuration torsion box 3, such as the one depicted in FIGS. 4a and 4b, is structurally based on a front spar 11 and a back spar 13 (understanding the terms front and back in relation to the flight direction of the aircraft), two upper and lower skins 19, 21 with a plurality of reinforcement stringers 25 and a plurality of inner intermediate longitudinal spars 15.

FIG. 5 shows an embodiment of a fitting 5 back-fitting 7 assembly for receiving and distributing local loads in a multi-spar torsion box 3.

FIG. 6a illustrates the known attachment of the fitting 5 back-fitting 7 assembly used both in multi-rib torsion boxes 1 and in multi-spar torsion boxes 3 using an angle fitting 6 to create the necessary planar surfaces between the different elements to enable attachment by means of bolts (not depicted).

Now describing the present invention, it must first be indicated that the basic idea of this invention is to provide a single component 9 for introducing and distributing local loads to an aircraft lift surface torsion box instead of the fitting 5 back-fitting 7 assembly of the prior art. This is schematically depicted in FIG. 6b, showing the component 9, made of one part, attached to the back spar 13 (or, where appropriate to the front spar 11). The single component 9 is therefore a single structural member capable of performing the functions of the mentioned fitting 5 and back-fitting 7, thus reducing the number of parts to be manufactured, assembled and mounted.

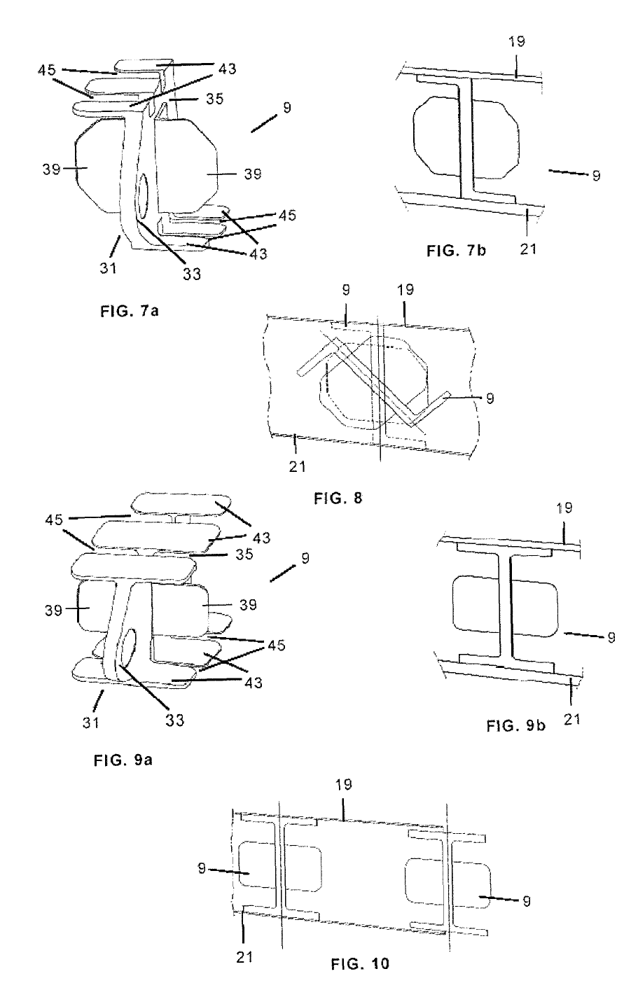

The following members of the configuration of the embodiment illustrated in FIGS. 7a and 7b must be pointed out:

A substantially planar web 31 with a first part in the form of a lug 33 for receiving the local load and a second part in the form of a rib web for the distribution of the load to the rest of the box.

Two flanges 39 for attaching the web 31 to the webs of each of the ends of the back spar 13 (or, where appropriate, the front spar 11). It must be observed that the back spar 13 must be cut at the location provided for the component 9.

Several flanges 43 for being attached to the upper skin 19 and lower skin 21 extending in opposite directions in relation to the plane of the web 31, such that the component 9 acquires a Z-shaped transverse profile.

Several gaps 45 in the areas of intersection with the back spar caps 13 (or, where appropriate, the front spar 11) and the reinforcement stringers 25. These gaps 45 must avoid any interference between the component 9 and the back spar 13 (or, where appropriate, the front spar 11) and or the reinforcement stringers 25, both in their final position and during the assembly process.

With this configuration of the component 9 as a single piece, the local load is introduced into the torsion box through the lug 33 and extends through the rib web 35 which distributes it to the skins 19, 21 and to the web of the back spar 13 (or, where appropriate, the front spar 11) through riveted attachments (not depicted) in the areas of the flanges 39, 43.

In the embodiment illustrated in FIGS. 9a, 9b, the only difference in the configuration compared to the embodiment just described is that the flanges 43 for being attached to the upper skin 19 and lower skin 21 extend on both sides of the plane of the web 31, such that the component 9 acquires a double-T shaped transverse profile.

In a preferred embodiment of the present invention for a multi-spar torsion box 3, the rib web 35 extends from the front or back spar (11, 13) to which the component (9) is assembled to the closest intermediate spar (15).

In a preferred embodiment of the present invention for a multi-rib torsion box 1, the rib web 35 extends from the two front and back spars 11, 13.

The manufacturing process recommended for the component 9 is RTM (resin transfer moulding) because it allows obtaining the complete structure in a single piece.

The assembly of the component 9 in a multi-rib torsion box is similar to the assembly of the ribs forming part of the box which is done before placing one of the skins. The installation of both parts of the back spar 13 (or, where appropriate, the front spar 11) is the last part of the installation of the component 9 within the box assembly process.

In a multi-spar box, the limitations of access to the inside of the box limit and determine the geometry of the component 9.

In the case of the configuration depicted in FIGS. 7a and 7b and as illustrated in FIG. 8, the component 9 rotated approximately 40° is introduced in the box. It is rotated to its final position inside the cell of the box where it will be located. Once the component 9 is placed, the two parts of the web of the back spar (or, where appropriate, the front spar 11) will be assembled thereon.

In the case of the configuration depicted in FIGS. 9a and 9b and as illustrated in FIG. 10, the component 9 is introduced vertically in the box in the area of the root rib (without this rib being assembled) and is moved along the box to its final position. Once it is fixed, the two parts of the web of the back spar (or, where appropriate, the front spar 11) will be assembled thereon.

Any modifications comprised within the scope defined by the following claims can be introduced in the preferred embodiment described above.

1. A component (9) of an aircraft lift surface torsion box (1, 3) for receiving and distributing a local load, the torsion box (1, 3) comprising at least two front and back spars (11, 13) and two upper and lower skins (19, 21) with reinforcement stringers (25), characterized in that it is made of a composite material as a single piece and in that its configuration comprises:
a substantially planar web (31) with a first part in the form of a lug (33) and a second part in the form of a rib web (35);
two flanges (39) to attach the web (31) with the webs of each of the ends of the front or back spar (11, 13) to which the component (9) is connected;
flanges (43) for being attached to the upper and lower skins (19, 21);
gaps (45) in the areas of intersection with the front or back spar caps(11, 13) to which the component (9) is connected and with the reinforcement stringers (25).

2. The component (9) of an aircraft lift surface torsion box (1, 3) according to claim 1, characterized in that said flanges (43) for being attached to the upper and lower skins (19, 21) extend in opposite directions in relation to the plane of the web (31) for each of the upper and lower skins (19, 21).

3. The component (9) of an aircraft lift surface torsion box (1, 3) according to claim 1, characterized in that said flanges (43) for being attached to the upper and lower skins (19, 21) extend on both sides of the plane of the web (31) for each of the upper and lower skins (19, 21).

4. The component (9) of an aircraft lift surface torsion box (1, 3) according to claims 1, characterized in that said torsion box (3) is a multi-spar box and in that the rib web (35) extends from the front or back spar (11, 13) to which the component (9) is assembled to the closest intermediate spar (15).

5. The component (9) of an aircraft lift surface torsion box (1, 3) according to claims 1, characterized in that said torsion box (1) is a multi-rib box and in that the rib web (35) extends from the front and back spars (11, 13).

6. An assembly process for assembling the component (9) object of claim 2 in a multi-spar torsion box (3), characterized in that it comprises the following steps:
a) providing the pre-assembled torsion box (3) with the two skins (19, 21);
b) providing a component (9) according to claim 2;
c) introducing said component (9) rotated a predetermined angle into the torsion box (3);
d) moving said component (9) to the site provided for its location and rotating it until it is correctly positioned;
e) coupling the component (9) with the ends of the front or back spar (11, 13) to which it is connected;
f) attaching the component (9) to the two skins (19, 21) and to the ends of the front or back spar (11, 13) to which it is connected.

7. An assembly process for assembling the component (9) object of claim 3 in a multi-spar torsion box (3), characterized in that it comprises the following steps:
a) providing the pre-assembled torsion box (3) with the two skins (19, 21);
b) providing a component (9) according to claim 3;
c) introducing vertically said component (9) into the torsion box (3);
d) moving said component (9) to the site provided for its location;
e) coupling the component (9) with the ends of the front or back spar (11, 13) to which it is connected;
f) attaching the component (9) to the two skins (19, 21) and to the ends of the front or back spar (11, 13) to which it is connected.
